(19) United States
(12) Patent Application Publication
(10) Pub. No.: US 2017/0309074 A1
(43) Pub. Date: Oct. 26, 2017

(54) AUTOMATIC VENDING MACHINE HAVING HOLOGRAPHIC PRODUCTS

(71) Applicant: THE MACKISS COMPANY INC., Daejeon (KR)

(72) Inventors: Woong-Rae CHO, Daejeon (KR); Keun-Soo KIM, Seoul (KR); Su-Jin KIM, Seoul (KR)

(73) Assignee: THE MACKISS COMPANY INC., Daejeon (KR)

(21) Appl. No.: 15/516,292

(22) PCT Filed: Sep. 16, 2015
(86) PCT No.: PCT/KR2015/009690

§ 371 Date: Mar. 31, 2017

(30) Foreign Application Priority Data
Oct. 8, 2014 (KR) 10-2014-0136079

(51) Int. Cl. G06T 19/00; G06F 15/16; G06Q 30/02; A63F 13/335; H04N 13/04; G03H 1/00; G06T 15/00; A63F 13/00

(52) U.S. Cl. CPC G06T 19/006; H04N 13/0459; G06F 15/16; G03H 1/0005; G06Q 30/02; A63F 13/335; A63F 13/00; G06T 15/00

(57) ABSTRACT

An automatic vending machine having holographic products comprises: a user interface unit; a display unit comprising one or multiple displays; an image display processing unit for processing to display, on the display unit, a thematic image including a plurality of image objects and one or more three-dimensional product image objects included within the thematic image; and a sale processing unit for processing the sale of an actual product corresponding to the three-dimensional product image object selected for purchase by means of the user interface, wherein the image display processing unit rotates the three-dimensional product image object in accordance with a user input from the user interface unit.

### TECHNICAL FIELD

The present invention relates to a product vending machine, and more particularly, to a product vending machine for displaying an image of a product and selling the product.

### BACKGROUND ART

In Korean Patent Registration No. 10-0881980, a product displaying and selling apparatus is disclosed. When a user who intends to purchase a displayed product selects list information corresponding to the corresponding displayed product, the apparatus for displaying and selling a product informs the user of various pieces of information of the corresponding product by text, an image, and voice, and performs payment for the purchased product through the Internet.

### DISCLOSURE

### Technical Problem

The present invention is directed to providing a holographic product vending machine capable of selling a product without holding a product to actually be sold.

Further, the present invention is directed to providing a holographic product vending machine capable of advertising and selling a product by interacting with a customer.

### Technical Solution

One aspect of the present invention provides a holographic product vending machine including a user interface (UI) unit, a display unit including one or a plurality of displays, an image display processing unit configured to process a display of a thematic image including a plurality of image objects and one or more three-dimensional (3D) product image objects included within the thematic image on the display unit, and a sale processing unit configured to process a sale of an actual product corresponding to a 3D product image object selected for purchase by means of the UI unit, wherein the image display processing unit rotates the 3D product image object in accordance with a user input from the UI unit.

The UI unit may include a gesture-based UI.

One of the plurality of image objects included in the thematic image may be a salesperson avatar which advertises and sells a product.

The image display processing unit may allow the salesperson avatar to interactively react in accordance with a recognition of a user or a gesture of the recognized user by means of the gesture-based UI.

When a payment for the actual product corresponding to the 3D product image object selected for purchase is completed, the sale processing unit may provide purchase authentication information, which allows a purchasing customer to receive the purchased product, to the purchasing customer. When the payment for the actual product corresponding to the 3D product image object selected for purchase is completed, the sale processing unit may transfer a delivery address input by a purchasing customer to a delivery server and instruct a delivery of the purchased product.

### Advantageous Effects

The disclosed holographic product vending machine can sell a product even without holding an actual product. Further, since a salesperson avatar, which is a holographic character, interactively reacts to a user and, specifically, recognizes a gesture of the user and interactively reacts to the user, the holographic product vending machine can actively induce the user to purchase a product.

### DESCRIPTION OF DRAWINGS

FIG. 1 is a block diagram of a holographic product vending machine in accordance with one embodiment of the present invention.

FIGS. 2 to 4 are reference views for describing rotation of a three-dimensional (3D) product image object in accordance with one embodiment of the present invention.

FIGS. 5 to 8 are reference views for describing an interactive reaction of an avatar through a gesture-based user interface (UI) in accordance with one embodiment of the present invention.

### MODES OF THE INVENTION

The above-described aspects and additional aspects of the present invention will become clear from exemplary embodiments that will be described with reference to the accompanying drawings. Hereinafter, in order to facilitate understanding and reproduction by those skilled in the art, the present invention will be described in detail by explaining exemplary embodiments.

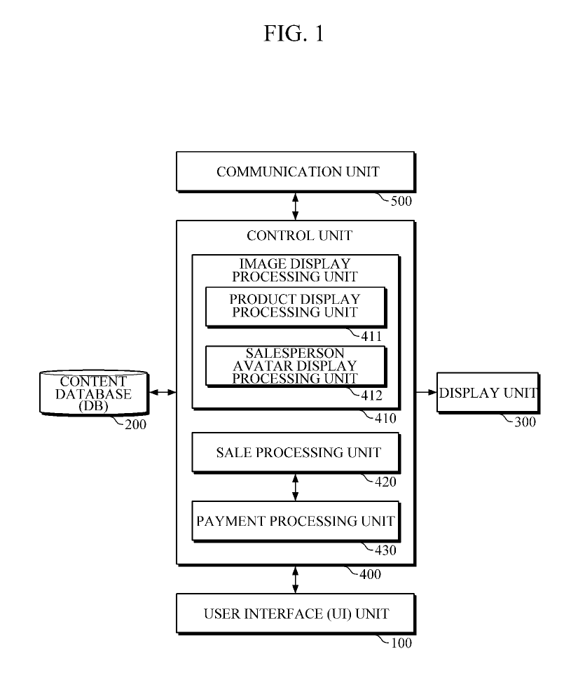

FIG. 1 is a block diagram of a holographic product vending machine in accordance with one embodiment of the present invention. A user interface (UI) unit 100 provides one or more UIs. The UI unit 100 may include at least one of a touch-based UI and a gesture-based UI. According to one aspect, the UI unit 100 may include a gesture-based UI. Gesture-based UI techniques may be divided into a contact method in which a body comes into direct contact with a device and a non-contact method in which a body does not come into direct contact with a device. In the non-contact method, a gyro sensor or a camera may be used to recognize a gesture of a user. According to the non-contact method, an approach of a user may be recognized and a specific gesture may also be recognized by photographing the user's motion or expression using a camera.

A content database (DB) 200 may store one or more pieces of content and the stored content may be holographic content. In one embodiment, thematic image content to be displayed on a display unit 300 may be stored in the content DB 200. A thematic image may include a plurality of image objects. For example, the thematic image may be an image including the Seine of Paris, a bridge crossing the Seine, buildings along the Seine, and tourists around the Seine. Further, one or more three-dimensional (3D) product image objects may be stored in the content DB 200. The 3D product image object is an image object representing a product to be actually sold, and 3D product image objects for a plurality of actual products may be stored in the content DB 200.

The display unit 300 includes one or a plurality of displays. In one embodiment, the display unit 300 may include the plurality of displays and display one large image. Each of the displays included in the display unit 300 may be a display for displaying a 3D image such as a hologram. The display unit 300 may display a plurality of image objects, and the displayed image objects may be objects which are pre-stored in the content DB 200 or received and played from an external server in real-time. For the latter case, the holographic product vending machine may further include a communication unit 500. The communication unit 500 may be a communication module for performing data communication with an external server, and may have a Transmission Control Protocol/Internet Protocol (TCP/IP)-based Internet communication function.

An image display processing unit 410 processes a display of image objects on the display unit 300. Such image objects may be 3D image objects such as holograms. In one embodiment, the image display processing unit 410 may process a display of a thematic image including a plurality of image objects and one or more 3D product image objects included in the thematic image. In another embodiment, the image display processing unit 410 may process a display of only 3D product image objects. Accordingly, a thematic image including a 3D product image object may be displayed on the display unit 300, or only a 3D product image object may be displayed. As described above, some image objects displayed on the display unit 300 may be received from an external server. Therefore, for example, the image display processing unit 410 may process a display of a thematic image on the display unit 300 by receiving the thematic image in real-time from an external server through the communication unit 500, and may process a display of a 3D product image object on the display unit 300 by extracting the 3D product image object from the content DB 200.

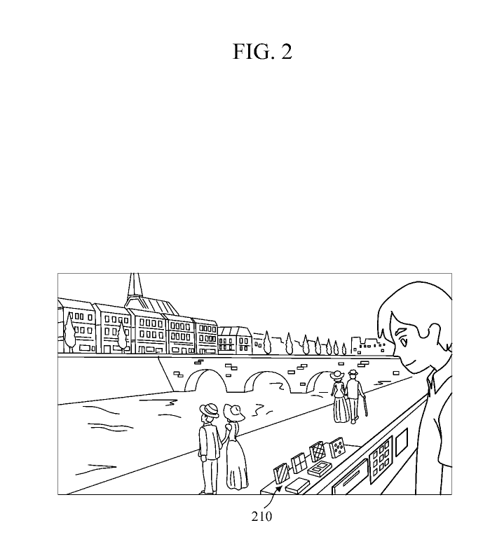

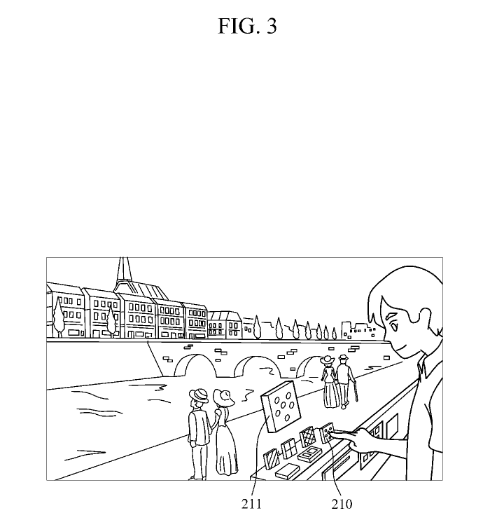

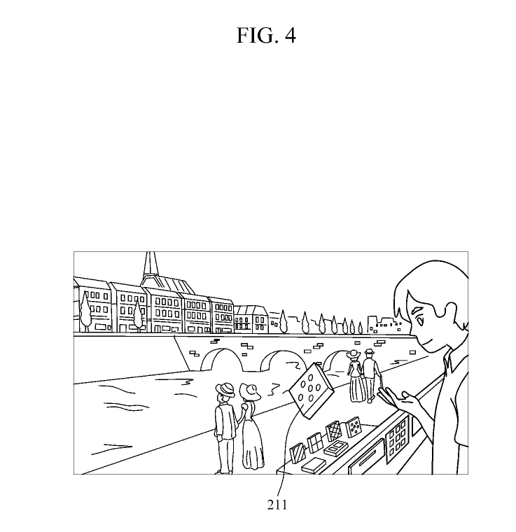

As illustrated in FIG. 1, the image display processing unit 410 includes a product display processing unit 411. The product display processing unit 411 serves to process a display of a 3D product image object. The product display processing unit 411 may process a display of a plurality of 3D product image objects on the display unit 300 by extracting the plurality of 3D product image objects from the content DB 200. Further, the product display processing unit 411 may rotate the 3D product image objects displayed on the display unit 300 in accordance with a user input through the UI unit 100. The user may see the 3D product image objects while rotating the 3D product image objects through a touch-based UI or a gesture-based UI. This will be described with reference to FIGS. 2 to 4. As illustrated in FIG. 2, the user may see a thematic image through the display unit 300, and may also see 3D product image objects 210 of products to be sold included in the thematic image. As illustrated in FIG. 3, when the user selects one of the 3D product image objects 210, the product display processing unit 411 enlarges the selected 3D product image object 210 and processes a display of the enlarged 3D product image on the display unit 300. In one embodiment, the product display processing unit 411 may process a display of an enlarged image object 211 on the display unit 300 by extracting the enlarged image object 211 from the content DB 200 instead of enlarging the selected 3D product image object 210 by itself. Further, as illustrated in FIG. 4, when the user makes a specific gesture to rotate the enlarged image object 211, the product display processing unit 411 rotates the enlarged image object 211 in accordance with the recognized gesture. Meanwhile, the product display processing unit 411 may process a display and rotation of the selected 3D product image object 210 on a screen without displaying the enlarged image object 211, or may process a rotation of the selected 3D product image object 210 at an original position without moving the selected 3D product image object 210.

A sale processing unit 420 processes a sale of an actual product corresponding to a 3D product image object selected for purchase by means of the UI unit 100. A payment processing unit 430 processes a payment for purchasing a product by the user. When the user selects a purchase by specifying one or more 3D product image objects by means of the UI unit 100, the payment processing unit 430 processes a payment therefor. Examples of payment methods may include a coin payment, a banknote payment, a card payment, and the like. When a payment processing is completed, the sale processing unit 420 processes a sale of the product selected by the user. In one embodiment, when the payment processing is completed, the sale processing unit 420 provides purchase authentication information to a purchasing customer. The purchase authentication information is information for authenticating a fact of the purchase so that the purchasing customer may receive a purchased product. The sale processing unit 420 may print the authentication information through a printing means, or may transmit the authentication information to a communication terminal of the purchasing customer using a phone number input by the purchasing customer. In another embodiment, when the payment processing is completed, the sale processing unit 420 may transfer a delivery address input by the purchasing customer by means of the UI unit 100 to a delivery server, and instruct a delivery of the product. Thus, the purchasing customer may receive the product without having to directly collect the product.

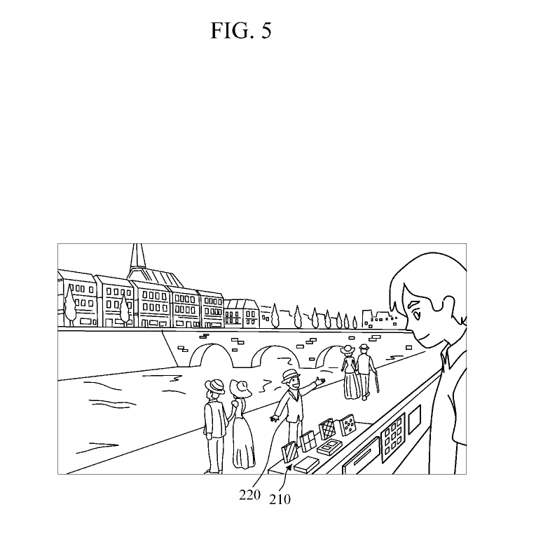

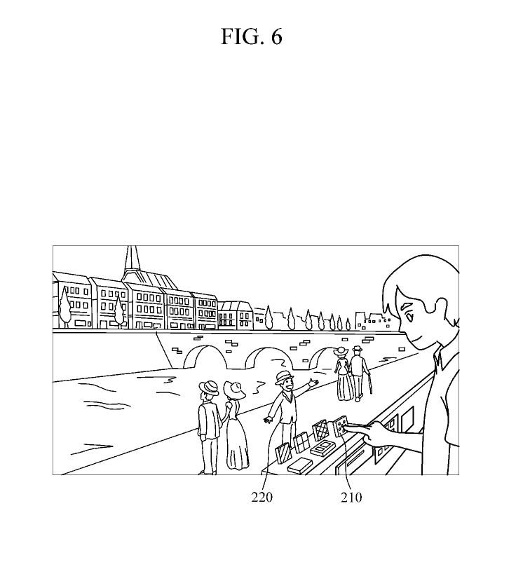

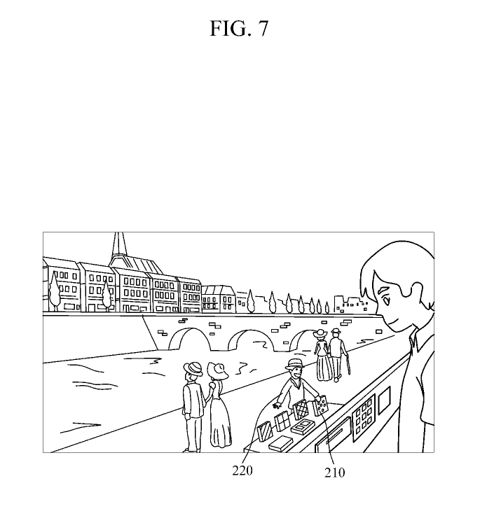

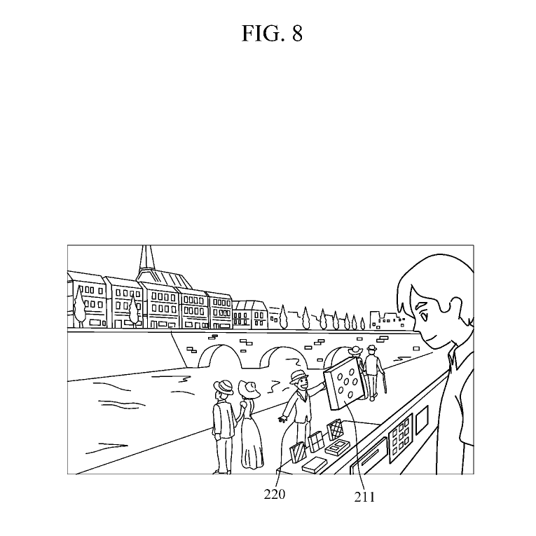

Meanwhile, the image display processing unit 410 may further include a salesperson avatar display processing unit 412. A salesperson avatar may be one of various 3D image objects included in a thematic image. Alternatively, the salesperson avatar may be a 3D image object independent of the thematic image. A salesperson avatar 220 serves to advertise and sell a product. In order for the salesperson avatar 220 to advertise and sell a product, a control unit 400 may match voice data for advertising and purchasing the product and an operation of the salesperson avatar 220, and output the voice data to the outside through a speaker. Here, the voice data may be pre-stored in the content DB 200. Meanwhile, the salesperson avatar display processing unit 412 allows the avatar to interactively react in accordance with a recognition of a user or a gesture of the recognized user by means of a gesture-based UI. This will be described with reference to FIGS. 5 to 8. When an approach of the user is recognized by means of the gesture-based UI, the salesperson avatar display processing unit 412 processes a display of the salesperson avatar 220 to react as illustrated in FIG. 5. Alternatively, the salesperson avatar display processing unit 412 may process the display of the salesperson avatar 220 when the approach of the user is recognized in a state in which the salesperson avatar 220 is not being displayed. The salesperson avatar display processing unit 412 makes the salesperson avatar 220 react differently in accordance with a recognition of a gesture (a movement, a facial expression, etc.) of the approaching user. That is, the salesperson avatar 220 interactively reacts in accordance with the user's movement, facial expression, and the like. For example, when the user selects one 3D product image object as illustrated in FIG. 6, the salesperson avatar display processing unit 412 makes the salesperson avatar pick up the selected 3D product image object 210 as illustrated in FIG. 7, and then provides the enlarged image object 211 as illustrated in FIG. 8. Motion data necessary for an operational change of the salesperson avatar 220 may be stored in the content DB 200, and the salesperson avatar display processing unit 412 may extract the corresponding motion data from the content DB 200 in accordance with the gesture of the user and process a display of the extracted motion data on the display unit 300.

While the present invention has been particularly described with reference to exemplary embodiments, it should be understood by those skilled in the art that various changes in form and details may be made without departing from the spirit and scope of the present invention. Therefore, the exemplary embodiments should be considered in a descriptive sense only and not for purposes of limitation. The scope of the invention is defined not by the detailed description of the invention, but by the appended claims, and encompasses all modifications and equivalents that fall within the scope of the appended claims and should be construed as being included in the present invention.

1. a holographic product vending machine comprising:
a user interface (UI) unit;
a display unit including one or a plurality of displays;
an image display processing unit configured to process a display of a thematic image including a plurality of image objects and one or more three-dimensional (3D) product image objects included within the thematic image on the display unit; and
a sale processing unit configured to process a sale of an actual product corresponding to a 3D product image object selected for purchase by means of the UI unit,
wherein the image display processing unit rotates the 3D product image object in accordance with a user input from the UI unit.

2. The holographic product vending machine of claim 1, wherein the UI unit includes a gesture-based UI.

3. The holographic product vending machine of claim 2, wherein one of the plurality of image objects included in the thematic image is a salesperson avatar which advertises and sells a product.

4. The holographic product vending machine of claim 3, wherein the image display processing unit allows the salesperson avatar to interactively react in accordance with a recognition of a user or a gesture of the recognized user by means of the gesture-based UI.

5. The holographic product vending machine of claim 1, wherein, when a payment for the actual product corresponding to the 3D product image object selected for purchase is completed, the sale processing unit provides purchase authentication information, which allows a purchasing customer to receive the purchased product, to the purchasing customer.

6. The holographic product vending machine of claim 1, wherein, when a payment for the actual product corresponding to the 3D product image object selected for purchase is completed, the sale processing unit transfers a delivery address input by a purchasing customer to a delivery server and instructs a delivery of the purchased product.
